(19) United States
(12) Patent Application Publication
(10) Pub. No.: US 2019/0030915 A1
(43) Pub. Date: Jan. 31, 2019

(54) THERMAL HEAD CONTROL APPARATUS, TAPE PRINTING APPARATUS COMPRISING THE SAME, AND THERMAL HEAD CONTROL HEAD

(71) Applicant: SEIKO EPSON CORPORATION, Tokyo (JP)

(72) Inventor: Naohiko AOYAGI, Azumino-shi (JP)

(73) Assignee: SEIKO EPSON CORPORATION, Tokyo (JP)

(21) Appl. No.: 16/064,947

(22) PCT Filed: Dec. 6, 2016
(86) PCT No.: PCT/JP2016/086169

§ 371 Date: Jun. 21, 2018

(30) Foreign Application Priority Data
Dec. 24, 2015 (JP) 2015-251073

(51) Int. Cl. B41J 2/355

(52) U.S. Cl. CPC B41J 2/355

(57) ABSTRACT

A thermal head control apparatus includes a plurality of head drivers including a plurality of switching circuits configured to on/off-drive a plurality of heating resistive elements provided in a thermal head. The thermal head and the plurality of head drivers are connected to connect the plurality of switching circuits and one heating resistive element.

### TECHNICAL FIELD

The present invention relates to a thermal head control apparatus controlling a thermal head driving for a thermal printer or the like, a tape printing apparatus including the same, and a thermal head control method.

### BACKGROUND ART

FIG. 8 is a block diagram depicting an overview of a control system for a thermal head in a known thermal printer. As depicted in the drawing, a thermal head 110 includes a plurality of heating resistive elements 111-1 to 111-n (n being an integer). The heating resistive elements 111-1 to 111-n connect at one end to a power supply line 112, while the other end connect to the heating element terminals 131-1 to 131-n of the head driver 120 of the thermal head.

The head driver 120 includes a shift resistor 121, latch circuits 122-1 to 122-n, AND gates 123-1 to 123-n, and MOS transistors 124-1 to 124-n. In this case, a data input terminal 132 supplies print data to a shift resistor 121. Each resistor of the shift resistor 121 supplies output to the latch circuits 122-1 to 122-n. An input terminal 133 supplies strobe signals to one input end of the AND gates 123-1 to 123-n, and the latch circuits 122-1 to 122-n supply output signals to the other input end. In addition, the AND gates 123-1 to 123-n supply output to the gates of the MOS transistors 124-1 to 124-n. Then, connecting the MOS transistors 124-1 to 124-n between the heating element terminals 131-1 to 131-n and the ground, the MOS transistors 124-1 to 124-n comprise switching circuits on/off-driving the heating resistive elements 111-1 to 111-n.

The data input terminal 132 supplies serial print data, which is converted from serial data to parallel data by the shift resistor 121, and then latched to the latch circuits 122-1 to 122-n. Then, when the strobe signals from the input terminal 133 are at a high level, the print data from the latch circuits 122-1 to 122-n is output to the gates of the MOS transistors 124-1 to 124-n via the AND gates 123-1 to 123-n.

Here, in a case where print data is “1 (high level)”, the output signals of the AND gates 123-1 to 123-n are at a high level, and the MOS transistors 124-1 to 124-n are on. When the MOS transistors 124-1 to 124-n are on, current flows to the heating resistive elements 111-1 to 111-n, and the temperature of the heating resistive elements 111-1 to 111-n rises. Thus, text, figures and other characters are printed on mediums receiving heat transfer printing via an ink ribbon and mediums responding to thermal energy.

PTL 1 describes controlling the quantity of heat generated by the heating resistive elements of thermal head based on the black printing rate in order to stabilize print quality. In this case, the configuration described in PTL 1 changes the energizing time and energizing frequency of heating elements (heating resistive element 111-1 to 111-n) with strobe signals, controlling the quantity of heat generated of heating elements.

### CITATION LIST

### Patent Literature

[PTL 1] JP-A-8-258313

### SUMMARY OF INVENTION

### Technical Problem

Thus, the configuration described in PTL 1, when controlling the quantity of heat generated by heating elements, controls the energizing time and energizing frequency of the heating elements with strobe signals. However, controlling the energizing time and energizing frequency of the heating elements produces problems, such as irregularities in printing time or long printing times due to print images. Therefore, controlling the quantity of heat generated by heating elements regardless of the energizing time and energizing frequency of heating elements can also be considered. In this case, when using the head driver 120 in FIG. 8, it is difficult to control the quantity of heat generated by heating elements regardless of the energizing time and energizing frequency of heating elements (heating resistive elements 111-1 to 111-n).

That is, the head driver 120 in FIG. 8 determines the quantity of heat generated by the heating resistive elements 111-11 to 111-n in accordance with the power supplied to the heating resistive elements 111-1 to 111-n, and the energizing time and energizing frequency of the heating resistive elements 111-1 to 111-n. Here, in order to control the quantity of heat generated by the heating resistive elements 111-1 to 111-n in accordance with the power supplied to the heating resistive elements 111-1 to 111-n, the voltage supplied to the heating resistive elements 111-1 to 111-n, or the current flowing the heating resistive elements 111-1 to 111-n, needs to be controlled. A booster circuit is required to control this voltage, which raises costs. In addition, changes need to be applied to the integrated circuit for the head driver 120 in order to control this current.

An object of the invention is to provide a thermal head control apparatus, a tape printing apparatus including the same, and a thermal head control method, capable of easily controlling the quantity of heat generated without affecting printing time.

### Solution to Problem

A thermal head control apparatus according to the invention includes a head driver including a plurality of switching circuits configured to on/off-drive a plurality of heating elements provided in a thermal head. The thermal head and the head driver are connected and the thermal head is controlled to connect the plurality of switching circuits and one heating element of the plurality of heating elements.

According to this configuration, by connecting the plurality of switching circuits to one heating element, it is possible to control the value of current flowing through heating elements. Consequently, it is possible to easily control the temperature of heating elements without affecting printing time.

In this case, the plurality of switching circuits are preferably configured to drive the plurality of heating elements with a constant current.

Also, the plurality of switching circuits preferably have internal resistance in accordance with an amount of change in a quantity of heat generated needed by the thermal head.

In this case, the internal resistance when the amount of change in the quantity of heat generated is great is preferably a large resistance value compared to when the amount of change in the quantity of heat generated is small.

According to this configuration, by enlarging the resistance value of the internal resistance of individual switching circuits, it is possible to enlarge the difference in the resistance value of the total internal resistance when changing the number of switching circuits simultaneously driving one heating element. When the resistance value of internal resistance is large, the current passing through internal resistance lessens, and the quantity of heat generated by heating elements decreases. When the resistance value of internal resistance becomes smaller, the current passing through internal resistance increases, and the quantity of heat generated by heating elements increases. Accordingly, when enlarging the amount of change in the quantity of heat generated, then the resistance value of the internal resistance of the switching circuits is large compared to when the amount of change in the quantity of heat generated is small.

A tape printing apparatus according to the invention includes the thermal head control apparatus described above, and a thermal head configured to be controlled by the thermal head control apparatus and print on print tape.

According to this configuration, it is possible to control the quantity of heat generated by heating elements regardless of the energizing time and energizing frequency of heating elements. Consequently, it is possible to easily control the temperature of heating elements without affecting printing time. In other words, thermal driving in accordance with high-speed printing and low-speed printing is possible.

A thermal head control method according to the invention, to be performed in ahead driver including a plurality of switching circuits configured to on/off-drive a plurality of heating elements provided in a thermal head, the thermal head control method including connecting the thermal head and the head driver to connect the plurality of switching circuits and one heating element of the plurality of heating elements, and controlling the number of switching circuits simultaneously driven in accordance with a quantity of heat generated required by the thermal head.

According to this configuration, by controlling the number of switching circuits simultaneously driving the plurality of heating resistive elements, it is possible to control the temperature of the heating resistive elements without affecting printing time.

### BRIEF DESCRIPTION OF DRAWINGS

FIG. 1 is a block diagram of a control system for a tape printing apparatus according to an embodiment.

FIG. 2 is a block diagram depicting an overview of a control system for a thermal head according to Exemplary Embodiment 1.

FIG. 3 is an equivalent circuit diagram (1) for describing a control system for a thermal head.

FIG. 4 is an equivalent circuit diagram (2) for describing a control system for a thermal head.

FIG. 5 is another equivalent circuit diagram (1) for describing a control system for a thermal head.

FIG. 6 is another equivalent circuit diagram (2) for describing a control system for a thermal head.

FIG. 7 is a block diagram depicting an overview of a control system for a thermal head according to Exemplary Embodiment 2.

FIG. 8 is a block diagram depicting an overview of a known control system for a thermal head.

### DESCRIPTION OF EMBODIMENTS

A tape printing apparatus employing a thermal head control apparatus and a thermal head control method according to Exemplary Embodiment 1 of the present invention will be described referring to appended drawings. This tape printing apparatus is a thermal printer with a mounted thermal head, and uses the thermal head to print on introduced print tape, and uses a cutter to cut printed sections of the print tape to make labels.

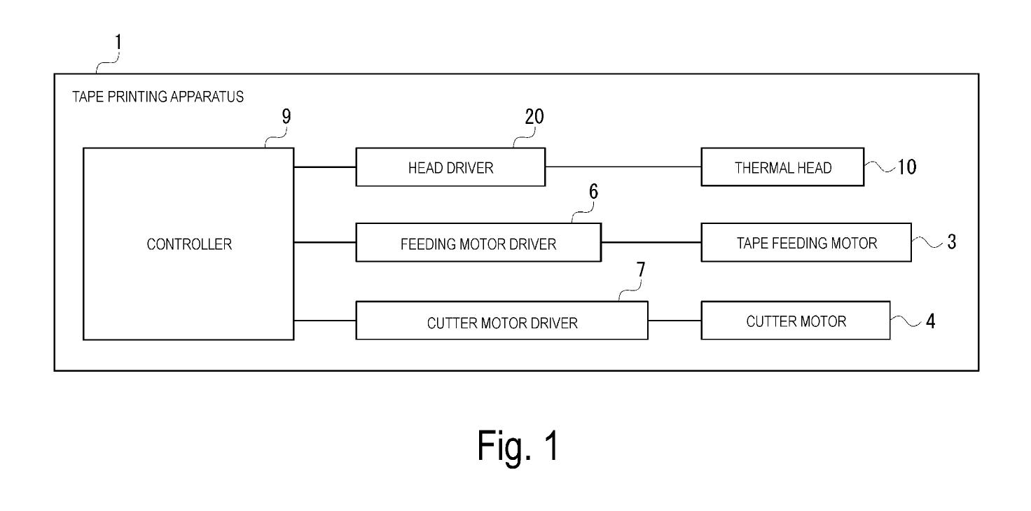

FIG. 1 is a block diagram of a control system for a tape printing apparatus 1. As depicted in the drawing, the tape printing apparatus 1 includes a thermal head 10 (print head), a tape feeding motor 3, and a cutter motor 4. In addition, the tape printing apparatus 1 includes a head driver 20 driving the thermal head 10, a feeding motor driver 6 driving the tape feeding motor 3, and a cutter motor driver 7 driving the cutter motor 4. The tape printing apparatus 1 further includes a controller 9 connected to each of these drivers 20, 6, 7.

The controller 9 includes a CPU (Central Processing Unit), ROM (Read Only Memory), and RAM (Random Access Memory), and controls the entire tape printing apparatus 1. For example, the controller 9 controls the thermal head 10 and tape feeding motor 3, via the head driver 20 and feeding motor driver 6, to print on the print tape. In addition, the controller 9, via the cutter motor driver 7, controls the cutter motor 4 to cut printed sections of the print tape.

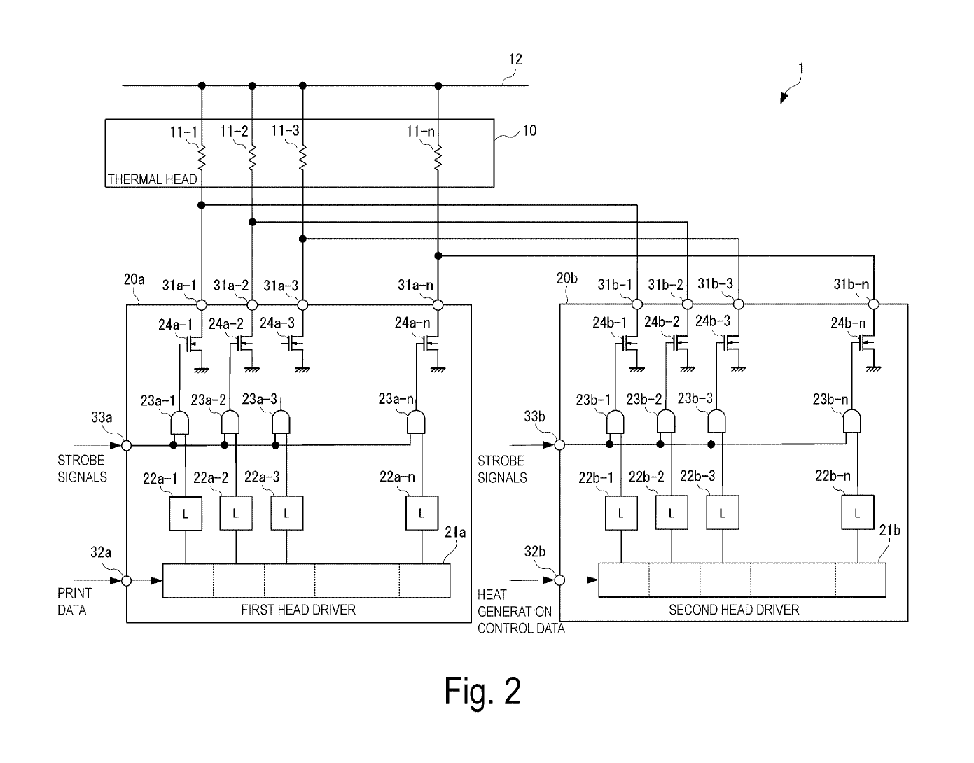

Here, the control system for the thermal head 10 according to Exemplary Embodiment 1 will be described referring to FIG. 2. As depicted in the drawing, the head driver 20 which is the control apparatus for the thermal head 10 is connected to the thermal head 10, and the head driver 20 includes a first head driver 20a and second head driver 20b.

The thermal head 10 includes an arranged plurality of heating resistive elements 11-1 to 11-n (n being an integer). The heating resistive elements 11-1 to 11-n at one end connect to the power supply line 12, and at the other end connect to heating element terminals 31a-1 to 31-a-n of the first head driver 20a, and heating element terminals 31b-1 to 31b-n of the second head driver 20b.

The first head driver 20a includes a shift resistor 21a, latch circuits 22a-1 to 22a-n, AND gates 23a-1 to 23a-n, and as an example, MOS transistors 24a-1 to 24a-n.

The shift resistor 21a is supplied with input data by a data input terminal 32a. The latch circuits 22a-1 to 22a-n are supplied with output by the resistors of the shift resistor 21a. The AND gates 23a-1 to 23a-n at one input end are supplied with strobe signals from an input terminal 33a for the strobe signals, and at the other input end are supplied with output signals of the latch circuits 22a-1 to 22a-n. In addition, the AND gates 23a-1 to 23a-n supply output to the gates of the MOS transistors 24a-1 to 24a-n.

Then, the MOS transistors 24a-1 to 24a-n are connected between the heating element terminals 31a-1 to 31a-n and the ground, and the MOS transistors 24a-1 to 24a-n include switching circuits on/off-driving the heating resistive elements 11-1 to 11-n.

Similarly, the second head driver 20b includes a shift resistor 21b, latch circuits 22b-1 to 22b-n, AND gates 23b-1 to 23b-n, and MOS transistors 24b-1 to 24b-n. In this case, the configuration of the second head driver 20b is identical to the first head driver 20a.

The data input terminal 32a of the first head driver 20a is supplied with one line of print data as serial data. In addition, the data input terminal 32b of the second head driver 20b is supplied with one line of heat generation control data corresponding to each dot of print data. Then, the input terminal 33a of the first head driver 20a and the input terminal 33b of the second head driver 20b are supplied with a common strobe signal.

Next, the operation of a tape printing apparatus 1 according to Exemplary Embodiment 1 will be described.

As described above, this tape printing apparatus 1 uses heat generation control data as well as print data. Heat generation control data sets the quantity of heat generated for the respective heating resistive elements 11-1 to 11-n per dot, which thus corresponds to the locations of print data dots. In the heat generation control data according to Exemplary Embodiment 1, “1 (high level)” is when the quantity of heat generated is large, and “0 (low level)” is when the quantity of heat generated is small.

The first head driver 20a converts print data from the data input terminal 32a from serial data to parallel data at the shift resistor 21a, and latches it to the latch circuits 22a-1 to 22a-n. While the strobe signals from input terminal 33a are at a high level, the latch circuits 22a-1 to 22a-n output print data to the gates of the MOS transistors 24a-1 to 24a-n via the AND gates 23a-1 to 23a-n. Here, when the strobe signals are at a high level, in a case where the print data is “1”, the output signals of the AND gates 23a-1 to 23a-n are at a high level, and the MOS transistors 24a-1 to 24a-n are on. Thus, current flows to the heating resistive elements 11-1 to 11-n, and the temperature of the heating resistive elements 11-1 to 11-n rises due to Joule heat effect. In other words, text, figures and other characters are printed on mediums receiving heat transfer printing via an ink ribbon and mediums responding to thermal energy.

On the other hand, the second head driver 20b converts heat generation control data from the data input terminal 32b from serial data to parallel data at the shift resistor 21b, and latches it to the latch circuits 22b-1 to 22b-n. While the strobe signals from the input terminal 33b are at a high level, the latch circuits 22b-1 to 22b-n output heat generation control data to the gates of the MOS transistors 24b-1 to 24b-n via the AND gates 23b-1 to 23b-n. Here, when the strobe signals are at a high level, in a case where the heat generation control data is “1”, the output signals of the AND gates 23b-1 to 23b-n are at a high level, and the MOS transistors 24b-1 to 24b-n are on. Thus, current increasingly flows to the heating resistive elements 11-1 to 11-n, and the temperature of the heating resistive elements 11-1 to 11-n further rises. Next, this will be described in detail.

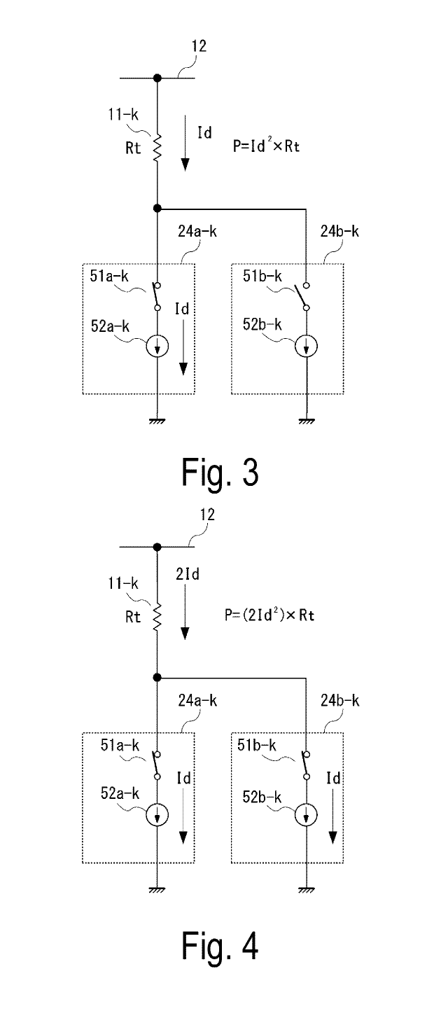

FIG. 3 and FIG. 4 depict a discretionary heating resistive element 11-k (k being a discretionary integer) from among the heating resistive elements 11-1 to 11-n, and depict the section of the switching circuits on/off-driving the heating resistive element 11-k with an equivalent circuit.

In Exemplary Embodiment 1, the heating resistive element 11-k at one end connects to the power supply line 12, and at the other end connects to one end of the MOS transistor 24a-k and the MOS transistor 24b-k, via the heating element terminal 31a-k of the first head driver 20a and the heating element terminal 31b-k of the second head driver 20b (see FIG. 2). In this case, the MOS transistor 24a-k and the MOS transistor 24b-k switching-drive the heating resistive elements 11-1 to 11-n.

Here, when the heating resistive elements 11-1 to 11-n are driven by constant current, a switch 51a-k and a current source 52a-k represent the MOS transistor 24a-k, and a switch 51b-k and a current source 52b-k represent the MOS transistor 24b-k. In addition, the current value of current source 52a-k and current source 52b-k is Id, and the resistance value of heating resistive element 11-k is Rt.

FIG. 3 depicts when the print data of a dot corresponding to heating resistive element 11-k is “1”, and the heat generation control data is “0”. In this case, the MOS transistor 24a-k of the first head driver 20a is on, but the MOS transistor 24b-k of the second head driver 20b is off, so the switch 51a-k is on, and the switch 51b-k is off. Thus, in this case, the heating resistive element 11-k is only driven by the current source 52a-k, and the current flowing to the heating resistive element 11-k is Id. Accordingly, power P supplied to the heating resistive element 11-k is,

P=Id²×Rt.

FIG. 4 depicts when the print data of a dot corresponding to the heating resistive element 11-k is “1”, and the heat generation control data is “1”. In this case, the MOS transistor 24a-k of the first head driver 20a is on, and the MOS transistor 24b-k of the second head driver 20b is also on, so the switch 51a-k is on, and the switch 51b-k is also on. Thus, in this case, the sum current of the current of the current source 52a-k and the current of the current source 52b-k drives the heating resistive element 11-k, and the current flowing to the heating resistive element 11-k is,

Id+Id=2Id.

Accordingly, the power P supplied to the heating resistive element 11-k is,

P=(2Id)²×Rt,

and the power P supplied to the heating resistive element 11-k increases.

In this way, in the tape printing apparatus 1 according to Exemplary Embodiment 1, the one thermal head 10 includes the two first and second head drivers 20a and 20b, and the thermal head 10 and the first and second head drivers 20a and 20b are connected so that the two switching circuits (MOS transistor 24a-k and MOS transistor 24b-k) are connected to a discretionary heating resistive element 11-k. Then, when the quantity of heat generated is small, the tape printing apparatus 1 drives the heating resistive element 11-k with only one switching circuit (MOS transistor 24a-k), and when the quantity of heat generated is great, it drives the heating resistive element 11-k with two switching circuits (MOS transistor 24a-k and MOS transistor 24-k). Thus, it is possible to control the quantity of heat generated by each of the heating resistive elements 11-1 to 11-n by changing the number of switching circuits simultaneously driving the heating resistive elements 11-1 to 11-n.

Furthermore, the example in FIG. 3 and FIG. 4 describes constant current from the current source 52a-k and the current source 52b-k driving the heating resistive element 11-k, but a switch may control the quantity of heat generated even when on/off-driving the heating resistive element 11-k.

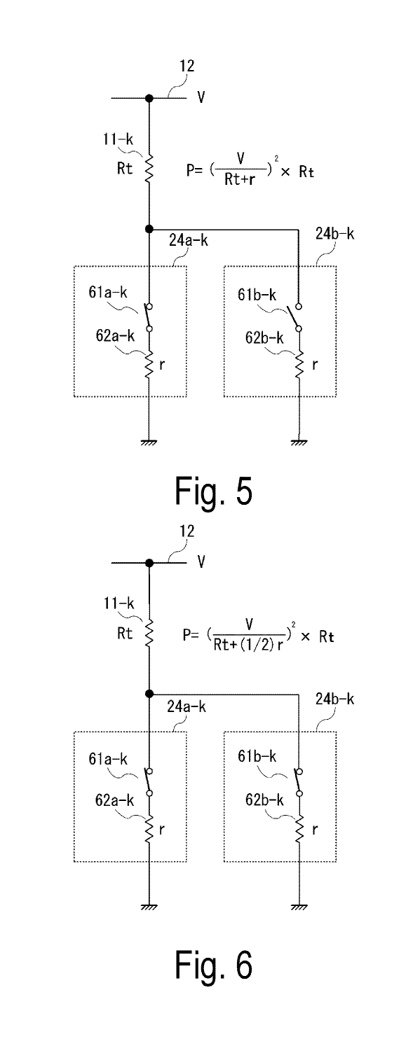

In other words, FIG. 5 and FIG. 6 depict an equivalent circuit when on/off driving the heating resistive element 11-k with a switch (modified example).

Here, the MOS transistor 24a-k of the first head driver 20a and the MOS transistor 24b-k of the second head driver 20b simply operate as a switch, and the value of internal resistances 62a-k and 62b-k of switches 61a-k and 61b-k is r. In addition, the voltage of the power supply line 12 is V, and the resistance value of the heating resistive element 11-k is Rt.

FIG. 5 depicts when the print data of a dot corresponding to the heating resistive element 11-k is “1”, and the heat generation control data is “0”. In this case, the switch 61a-k is on, and the switch 61b-k is off. The value of the internal resistance 62a-k of the switch 61a-k is r. Accordingly, the power P supplied to the heating resistive element 11-k is,

P=(V/(Rt+r))²×Rt.

FIG. 6 depicts when the print data of a dot corresponding to heating resistive element 11-k is “1”, and the heat generation control data is “1”. In this case, the switch 61a-k is on, and the switch 61b-k is also on. The value of the internal resistances 62a-k and 62b-k of the switches 61a-k and 61b-k is r. Accordingly, the power P of the heating resistive element 11-k is,

P=(V/(Rt+(½)r))²×Rt,

and the power P supplied to the heating resistive element 11-k increases.

In addition, from the formula above, the internal resistance r is needed in order to control the quantity of heat generated, and the controlled-variable of the quantity of heat generated by the heating resistive element 11-k depends upon the internal resistance r. When the amount of change in the quantity of heat generated is great, the internal resistance r may have a large resistance value, and when the amount of change in the quantity of heat generated is small, the internal resistance r may have a small resistance value. The internal resistance r is set in accordance with the needed amount of change in the quantity of heat generated.

Thus, the tape printing apparatus 1 according to Exemplary Embodiment 1 makes it possible to set the quantity of heat generated by each of the heating resistive elements 11-1 to 11-n of the thermal head 10 per dot. In addition, being able to set the quantity of heat generated by each of the heating resistive elements 11-1 to 11-n of the thermal head 10 makes possible the following controls.

(1) Continuous black dots are large in the amount of heat stored in a thermal recording medium (medium receiving heat transfer printing via an ink ribbon or medium responding to thermal energy), reducing the quantity of heat generated by heating resistive elements, and stabilizing print quality. However, continuous black dots increase the likelihood of ink ribbon breaks and the like due to overheating. Thus, by reducing the quantity of heat generated by heating resistive elements with continuous black dots, overheating is prevented and ink ribbon breaks and the like are inhibited. In addition, in order to prevent printing defects, ink ribbon breaks and the like due to overheating with continuous black printing patterns, the quantity of heat generated by heating resistive elements is variably controlled to determine the optimal quantity of heat generated.

(2) Minutely adjust the quantity of heat generated by heating resistive elements to lessen power consumption.

(3) The quantity of heat generated by heating resistive elements can be increased and print quality improved when ambient and starting temperature are low.

(4) Control the quantity of heat generated by heating resistive elements for gradation expression.

(5) Use ink that discolors according to temperature to realize color printing.

Further, the use of print media that may be temperature-processed and overheating some heating resistive elements to process products using the thermal head 10 may be considered. An example is overheating some heating resistive elements to cut or make holes (perforate) print media (print tape, ink ribbons).

Furthermore, in the example in FIG. 2, connecting the two first and second head drivers 20a and 20b to each of the heating resistive elements 11-1 to 11-n of the one thermal head 10 makes possible two-stage control of the quantity of heat generated by each of the heating resistive elements 11-1 to 11-n of the thermal head 10. Naturally, further connecting a plurality of head drivers to each of the heating resistive elements 11-1 to 11-n of the one thermal head 10 makes it possible to control the quantity of heat generated by each of the heating resistive elements 11-1 to 11-n in multiple stages. For example, connecting three head drivers 20 to each of the heating resistive elements 11-1 to 11-n of the one thermal head 10 makes it possible to control the quantity of heat generated by the heating resistive elements 11-1 to 11-n in three stages in accordance with the number of simultaneously driving switching circuits.

In addition, for example, it is possible to print in three primary colors (C (cyan), M (magenta), and Y (yellow)), using an ink that discolors according to temperature (thermochromic material), connecting three head drivers 20 to each of the heating resistive elements 11-1 to 11-n of the one thermal head, supplying print data for three primary colors to each head driver 20, and variably controlling the quantity of heat generated by each head driver 20.

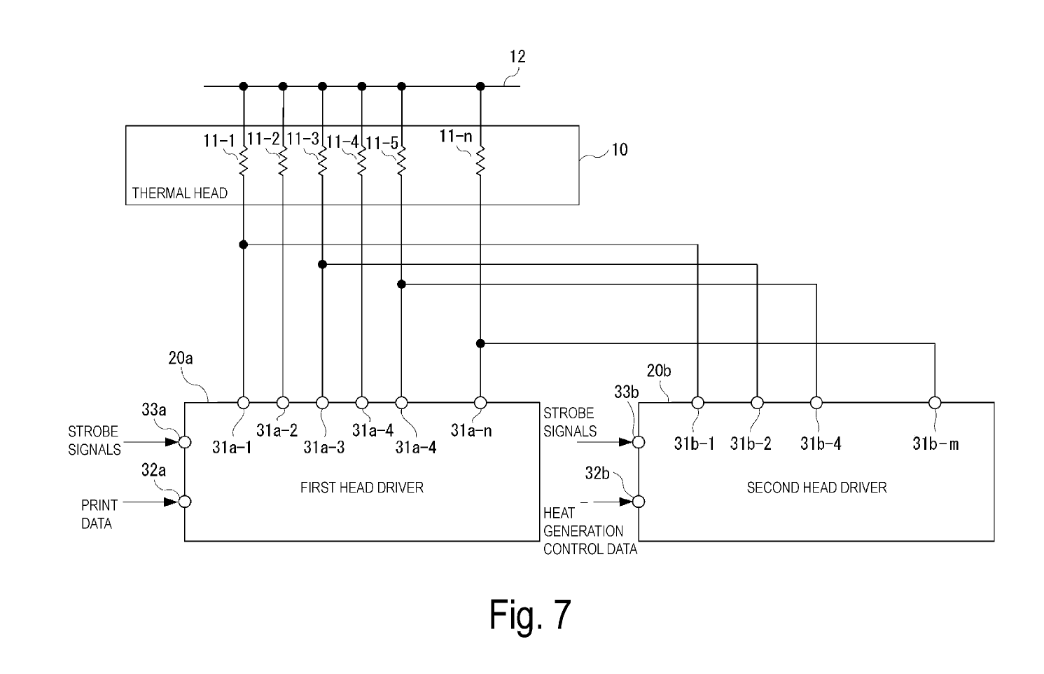

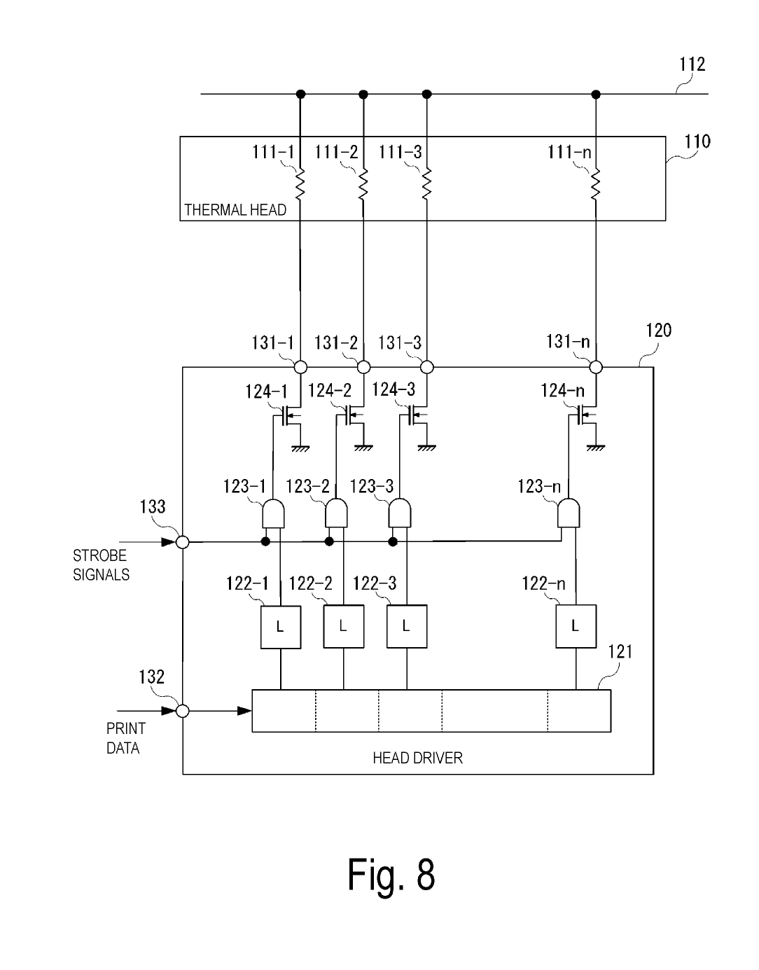

Next, a control system for a thermal head 10 according to Exemplary Embodiment 2 will be described referring to FIG. 7. As depicted in the drawing, this embodiment connects the two head drivers 20a and 20b to alternating heating resistive elements 11-1, 11-3, and so on, while connecting the one head driver 20a to heating resistive elements 11-2, 11-4, and so on. Other configurations are identical to Exemplary Embodiment 1.

Unlike Exemplary Embodiment 1, in this embodiment, the two first and second head driver 20a and 20b are connected to alternating heating resistive elements 11-1, 11-3, and so on, so it is possible to control only the quantity of heat generated for alternating dots. This makes it possible to expect adequate printing effects even with a configuration in which only the quantity of heat generated for alternating dots is controlled, without requiring control of the quantity of heat generated for all dots, particularly when controlling the quantity of heat generated in order to stabilize print quality.

In addition, this embodiment makes it possible to reduce the number of dots of the second head driver 20b used for control of the quantity of heat generated to less than the number of dots of the first head driver used for control of print data. This enables device miniaturization and cost reduction. For example, in a case where the first head driver 20a includes 128 dots, then 64 dots may be used for the second head driver 20b.

In addition, in Exemplary Embodiment 1, the first head driver 20a used for control of print data, and the second head driver 20b used for control of the quantity of heat generated are separately provided, but this embodiment does not need to specially include a separate second head driver 20b used for control of the quantity of heat generated. For example, in a case where the number of dots of the thermal head 10 is 96 dots, and the number of dots of the head drivers 20 provided as integrated circuits is 64 dots, then the two first and second 64-dot head drivers 20a and 20b switch drive the 96-dot thermal head 10. In this case, it generates a surplus of (128-96=32) dots. It is possible to effectively utilize the surplus 32-dot switching circuits as the head driver 20 used for control of the quantity of heat generated.

The invention is not limited to the embodiments described above, and various modifications and applications can be made without departing from the spirit of the invention. For example, the invention may be applied to a thermal printer other than a tape printing apparatus 1.

### REFERENCE SIGNS LIST

1 . . . Tape printing apparatus, 10 . . . Thermal head, 11-1 to 11-n . . . Heating resistive elements, 20 . . . Head driver, 20a . . . First head driver, 20b . . . Second head driver, 24a-1 to 24a-n, 24b-1 to 24b-n . . . MOS transistors

1. A thermal head control apparatus, comprising:
a head driver including a plurality of switching circuits configured to on/off-drive a plurality of heating elements provided in a thermal head; wherein the thermal head and the head driver are connected and the thermal head is controlled to connect the plurality of switching circuits and one heating element of the plurality of heating elements.

2. A thermal head control apparatus according to claim 1, wherein
the plurality of switching circuits are configured to drive the plurality of heating elements with a constant current.

3. A thermal head control apparatus according to claim 1, wherein
the plurality of switching circuits have internal resistance in accordance with an amount of change in a quantity of heat generated required by the thermal head.

4. A thermal head control apparatus according to claim 3, wherein
a controlled-variable of a quantity of heat generated by the plurality of heating elements depends upon the internal resistance.

5. A tape printing apparatus, comprising:
the thermal head control apparatus according to claim 1; and
a thermal head configured to be controlled by the thermal head control apparatus and print on print tape.

6. A thermal head control method to be performed in a head driver including a plurality of switching circuits configured to on/off-drive a plurality of heating elements provided in the thermal head, the thermal head control method comprising:
connecting the thermal head and the head driver to connect the plurality of switching circuits and one heating element of the plurality of heating elements; and
controlling the number of switching circuits simultaneously driven in accordance with a quantity of heat generated required by the thermal head.
